(19) United States
(12) Patent Application Publication
(10) Pub. No.: US 2020/0231904 A1
(43) Pub. Date: Jul. 23, 2020

(54) A SOAP BAR

(71) Applicant: BASF SE, Ludwigshafen (DE)

(72) Inventors: Peter Hoessel, Ludwigshafen (DE); Helmuth Voellmar, Ludwigshafen (DE); Johannes Crotogino, Monheim (DE); Hans-Martin Haake, Düsseldorf-Holthausen (DE)

(21) Appl. No.: 16/632,664

(22) PCT Filed: Jul. 25, 2018
(86) PCT No.: PCT/EP2018/070174

§ 371 Date: Jan. 21, 2020

(30) Foreign Application Priority Data
Aug. 2, 2017 (EP) 17184401.2

(51) Int. Cl. C11D 3/37; C11D 3/50; C11D 9/00; C11D 9/22; C11D 9/44

(52) U.S. Cl. CPC C11D 3/3761; C11D 3/50; C11D 9/007; C11D 13/00; C11D 9/442; C11D 3/3753; C11D 3/3776; C11D 9/225

(57) ABSTRACT

The present invention relates to a soap bar comprising soap, at least one perfume oil, at least one polymer, optionally water, and optionally further known cosmetic ingredients other than the soap, the perfume oil, the polymer and the water, wherein the at least one polymer is a water-soluble polymer, wherein the polymer has a water solubility of at least 0.01 g of polymer in 100 g of water at 20° C. at one or more than one pH value in the range between (4) and (9), and wherein the at least one polymer is selected from the group consisting of a polymer in which more than 20 wt % of the repeating units of the polymer are repeating units derived from at least one ethylenically unsaturated, polymerizable monomer having at least one acid group, and a polymer comprising repeating units derived from N-vinylpyrrolidone, wherein the proportion of these repeating units in the polymer is at least 50 wt %.

The present invention relates to a soap bar comprising soap, at least one perfume oil, at least one polymer, optionally water, and optionally further known cosmetic ingredients other than the soap, the perfume oil, the polymer and the water, wherein the at least one polymer is a water-soluble polymer, wherein the polymer has a water solubility of at least 0.01 g of polymer in 100 g of water at 20° C. at one or more than one pH value in the range between 4 and 9, and wherein the at least one polymer is selected from the group consisting of a polymer in which more than 20 wt % of the repeating units of the polymer are repeating units derived from at least one ethylenically unsaturated, polymerizable monomer having at least one acid group, and a polymer comprising repeating units derived from N-vinylpyrrolidone, wherein the proportion of these repeating units in the polymer is at least 50 wt %.

The processability and the consistency of bar soaps is important to the producer and appearance is important for the user.

The smell of bar soaps (also called soap bars) is important to the user. Soap bars are generally additized with perfume in order to improve their smell. This smell is desired to be intensive even at very low levels of perfume and to persist as long as possible in the storage of the soap bars.

The perfume used to improve the smell of soap bars is generally a perfume oil. A perfume oil is a scent. The scent may be an essential oil of vegetable or animal origin. The scent may also be a synthetic scent.

Soap bars can be produced using soap in the narrower sense, i.e., sodium salts of fatty acids. The fatty acids in question are usually linear aliphatic monocarboxylic acids of mostly 12 to 18 carbon atoms. The sodium in sodium salts of fatty acids is not of 100% purity, it can contain up to 10 wt % potassium instead of sodium.

Soap bars can also be produced using syndets (“synthetic detergents”). Throughout the present text the term soap is to be understood as meaning that it comprises not only soap in the narrower sense, i.e. sodium salts of fatty acids, but also syndets. Syndets are pH-neutral. Syndets are based, for example, on sodium salts of acyl isethionates, sodium salts of acyl glutamates, sodium salts of alky sulfoacetates, sodium salts of fatty alcohol sulfates or sodium salts of fatty alcohol sulfosuccinates.

Bar soap generally comprises water, or it is too brittle. The water content of soap is typically between 35 wt % (on direct saponification of fatty acids) and 14 wt % (toilet soap).

U.S. Pat. No. 3,772,215 discloses fragrant materials entrapped in water soluble hydroxyalkyl acrylate or methacrylate polymers, wherein these polymers comprise 0.5 to 20 wt % of a water solubilizing copolymerizable monomer which can be an acidic monomer.

US 2009/0082239 discloses a soap bar comprising water soluble agar agar polymer.

Regrettably, once manufactured, bar soaps are very quick to lose their smell, or the smell weakens.

The problem addressed by the present invention is that of improving the smell of soap bars comprising a perfume to the effect that either the smell of the as-produced soap bar is intensified for a given amount of perfume, or that the lessening of the smell of the soap bar for a given amount of perfume after storage of the soap bar is decreased, or that both effects occur.

The problem is solved by the soap bar according to the claims of the present document. The soap bar according to the main claim is one subject of the present invention. The dependent claims are directed to special embodiments of the soap bar according to the present invention.

The present invention further provides the method according to the independent method claim of the present document.

A water-soluble polymer within the meaning of the present invention is a polymer which has a water solubility of at least 0.01 g of polymer in 100 g of water at 20° C. at one or more than one pH value in the range between 4 and 9, preferably a water solubility of at least 0.1 g of polymer in 100 g of water at 20° C. at one or more than one pH value in the range between 4 and 9.

The at least one ethylenically unsaturated, polymerizable monomer having at least one acid group can be selected from the group consisting of acrylic acid, methacrylic acid, maleic acid, fumaric acid, itaconic acid, aconitic acid, cinnamic acid, crotonic acid, cyclohexene, carboxylic acid, propiolic acid, mesaconic acid, citraconic acid, vinyl sulfonic acid, p-vinylbenzenesulfonic acid, partial esters such as mono 2-hydroxyethyl citraconate, mono 2-hy-droxypropyl itaconate, mono 2-hydroxyethyl itaconate, mono 2-hydroxypropyl citraconate, mono 2-hydroxyethyl maleate, mono 2-hydroxypropyl fumarate, mono methyl itaconate, monoethyl itaconate, mono methyl Cellosolve itaconate (methyl Cellosolve is the monomethyl ether of diethylene glycol), mono methyl Cellosolve maleate and mono-2-hydroxyethyl aconitate.

Further suitable syndets are described in “Andreas Domsch: Die kosmetischen Präparate; Band 2: Wässrige and tensidhaltige Formulierungen; 4th edition; Verlag für chemische Industrie; H. Ziolkowski KG, Augsburg; pages 251-257”.

Beyond the recited repeating units in the recited quantitative proportions, the polymers of the invention may comprise repeating units derived from any desired known monomers comprising at least one polymerizable ethylenically unsaturated double bond.

Allylpentaerythritol is a mixture of the di-, tri- and tetraallyl ether. The abbreviation EO in the polymer formulae stands for “derived from ethylene oxide”, i.e. for the group —O—CH2-CH2-O—.

Positive side effects of adding the polymer according to the present invention to the bar soap for retaining perfume smell are better processability and better consistency of the soap in the soap machine and appearance of the final bar soap. The processability and consistency is important to the producer. Depending on the bar soap formula the material can appear too dry or too wet. In the first case the soap can look inhomogeneous, coarse and crumbly. In the second case the soap feels oversoft and sticky and can be crushed manually. Adding the polymer stabilizes the bar soap mass in an optimal area for extrusion and pressing. The appearance is important to the customer. In dry condition the surface of the bar soap is to be smooth, homogeneous, shiny and non-sticky. Adding the polymer enhances those surface properties.

The soap bar of the present invention may optionally comprise further known cosmetic ingredients other than the soap, the perfume oil, the polymer and the water. Which ingredients are suitable in particular will now be described.

The soap bar of the present invention can also comprise any or all of the following ingredients used for example to increase its shelf life, aesthetics or functionality.

Vitamins such as vitamin A and E, and vitamin alkyl esters such as vitamin C alkyl esters; lipids such as cholesterol, cholesterol esters, lanolin, ceramides, sucrose esters, and pseudo-ceramides; liposome forming materials such as phospholipids, and suitable amphiphilic molecules having two long hydrocarbon chains; essential fatty acids, poly unsaturated fatty acids, and sources of these materials; triglycerides of unsaturated fatty acids such as sunflower oil, primrose oil, avocado oil, almond oil; vegetable butters formed from mixtures of saturated and unsaturated fatty acids such as shea butter; mineral such as sources of zinc, magnesium, and iron; skin conditioners such as silicone oils, gums and modifications thereof such as linear and cyclic polydimethylsiloxanes, amino, alkyl, and alkylaryl silicone oils; hydrocarbons such as liquid paraffins, petrolatum, VASELINE™, microcrystalline wax, ceresin, squalene, pristan, paraffin wax and mineral oil; conditioning proteins such as milk proteins, silk proteins and glutins; cationic polymers as conditioners which may be used include Quatrisoft® LM-200 Polyquaternium-10, Polyquaternium-11, Polyquaternium-16, Polyquaternium-24, Polyquatermium-39, Polyquaternium-46, Polyquaternium-55, Polyquaternium-68, Merquat® Plus 3330, and Jaguar® type conditioners. Humectants such as glycerol, sorbitol, and urea emolients such as esters of long chain fatty acids, such as isopropyl palmitate and cetyl lactate.

Further optional agents include anti-acne agents such as salicylic acid, lactic acid, glycolic acid, and citric acid, and benzoyl peroxide (also an anti-microbial agent); oil control agents including sebum suppressants, mattifiers such as silica, titanium dioxide, oil absorbers, such as microsponges; astringents including tannins, zinc and aluminium sales, plant extracts such as from green tea and Witchhazel (Hammailes); scrub and ex-foliating particles, such as polyethylene spheres, agglomerated silica, sugar, ground pits, seeds, and husks such as from walnuts, peach, avocado, and oats, salts; cooling agents such as menthol and its various derivatives and lower alcohols; fruit and herbal extracts; skin calming agents such as aloe vera; essential oils such as mentha, jasmine, camphor, white cedar, bitter orange peel, ryu, turpentine, cinnamon, bergamot, citrus unshiu, calamus, pine, lavender, bay, clove, hiba, eucalyptus, lemon, starflower, thyme, peppermint, rose, sage, menthol, cineole, eugenol, citral, citronelle borneol, linalool, geranoil, evening primrose, camphor, thymol, spirantol, penene, limonene and terpenoid oils; Sun-screens such as 2,4,6-Trianilino-(p-carbo-2′-Ethylhexyl-1′-oxy)-1,3,5-Triazin (Uvinul® 150 from BASF), 2-Hydroxy-4-Methoxybenzophenone-5-Sulfonic Acid (Uvinul® MS40 from BASF), 2-Cyano-3,3-Diphenyl Acrylic Acid, 2-Ethylhexyl Ester (Uvinul® N539 from BASF), 4-Bis(polyethoxy)para-aminobenzoic acid polyethoxyethylester (Uvinul® P25 from BASF), Diethylamino Hydroxybenzoyl Hexyl Benzoate (Uvinul®A Plus from BASF), Methylene Bis-Benzotriazolyl Tetramethylbutylphenol (Tinosorb® M from BASF), Bis-Ethylhexyloxyphenol Methoxyphenyl Triazine (Tinosorb® S from BASF), 4-tertiary butyl-4′-methoxy dibenzoylmethane (available under the trade name PARSOL 1789™ from Givaudan) and/or 2-ethyl hexyl methoxy cinnamate (Uvinul®MC80 from BASF or PARSOL MCX from Givaudan) or other UV-A and UV-B sun-screens may also be incorporated.

Other benefit agents that can be employed include anti-ageing compounds and skin lightening agents, antioxidants such as, for example, butylated hydroxytoluene (BHT) may be used advantageously in amounts of about 0.01 wt % or higher if appropriate.

Other ingredients which may be included are physical ex-foliants such as polyoxyethylene beads, walnut shells and apricot seeds. Incorporation of such physical exfoliants can give added benefits over and above the chemical exfoliation provided by alpha-hydroxy acids. Such added benefits are highly desired by the consumers. The particle size of the ex-foliants preferably lies between 50 microns to 1000 microns, more preferably 100 microns to 500 microns, most preferably 100 to 200 microns.

Another group of optional ingredients is optical modifiers which are defined as materials that modify the optical texture or introduce a pattern to increase the distinctiveness of the bar. Examples of suitable optical modifiers include speckles/bits such as ground fruit pits, seeds, polyethylene beads, mineral agglomerates, and loofha; eflective plate-like particles such as mica; pearlizing agents such as coated micas, and certain waxes; wax/plastic slivers that resemble for example fruits slices; vegetable or fruit slivers, mattefiers such as TiO2 and mixtures of the above.

Further, the bar composition of the invention may include crystalline or amorphous aluminium hydroxide. The said aluminium hydroxide can be generated in-situ by reacting fatty acids and/or non-fatty mono- or polycarboxylic acids with sodium aluminate, or can be prepared separately by reacting fatty acids and/or non-fatty mono- or polycarboxylic acids with sodium aluminate and adding the reaction product to the soap. Another class of hardening agents are insoluble inorganic or mineral solids that can structure the discontinuous phase by network formation or space-filling. These include fumed, precipitated or modified silica, alumina, calcium carbonate, kaolin, and talc. Alumino-silicate clays especially synthetic or natural hectorites can also be used. In addition to the benefit agents, suitable bar structurants that provide integrity to the bar could also be used. Water insoluble structurants also have a melting point in the range 40-100° C., more preferably at least 50° C., notably so0c to 90° C.

Suitable materials which are particularly envisaged are fatty acids, particularly those having a carbon chain of 12 to 24 carbon atoms. Examples are lauric, myristic, palmitic, stark, arachidic and behenic acids and mixtures thereof. Sources of these fatty acids are coconut, topped coconut, palm, palm kernel, babassu and tallow fatty acids and partially or fully hardened fatty acids or distilled fatty acids. Other suitable water insoluble structurants include alkanols of 8 to 20 carbon atoms, particularly cetyl alcohol. These materials generally have a water solubility of less than 5 g/litre at 20° C. Other structurants may include particulate solids such as talc, starch (e.g., maltodextrin) or clay. The relative proportions of the water soluble structurants and water insoluble structurants govern the rate at which the bar wears during use. The presence of the water-insoluble structurant tends to delay dissolution of the bar when exposed to water during use and hence retard the rate of wear.

Further, the composition can be made multi-coloured, e.g., striped, through the judicious use of dye as is well known in the art.

The benefit agents generally comprises about 0-25 wt % by wt. of the composition, preferably 5-20 wt %, and most preferably between 2 and 10 wt %.

Bar compositions of the invention typically have pH of about 6 to 11, preferably above 7. The amount of water could differ in the case of cast bars.

Further known cosmetic ingredients other than the soap, the perfume oil, the polymer and the water that may be used for the purposes of the present invention have been described in “Karlheinz Schrader, Andreas Domsch: Cosmetology—Theory and Practice Volume 2; Verlag für chemische Industrie; H. Ziolkowski GmbH Augsburg; 1^{st} edition 2005; pages 205-215”. Amongst those are plastilizers (e.g. fatty alcohols or glycerin monostearate), re-fatteners (e.g. petrolatum, mineral oils, triglycerides, lecithin or lanolin), stiffening agents (e.g. starches, starch derivates, titanium dioxide, talc), inorganics salts (e.g. sodium triphosphate, sodium tetraphosphate, ammonium carbonate, potassium chloride, sodium chloride, trisodium phosphate, potassium carbonate), organic acids (e.g. citric acid), fragrances, colorants, antioxidants (e.g. BHT), chelating agents (e.g. EDTA), cationic polymers (e.g. polyquaternium-10), carboxymethyl cellulose, protein hydrolysates (e.g. Gluadin products), carbomer, triclosan, farnesol, polyols (e.g. glycerin, propylene glycol), sugar, alcohols, vegetable oils (e.g. coconut oil, castor oil), oils and fats of animal origin (e.g. tallow).

### EXAMPLES

% ages are wt % except when otherwise stated.

### Water Content of Soap Bars Obtained

The examples which follow comprise the production of soap bars on the basis of soap noodles. The soap noodles comprise 12 wt % of water. “Soap 1: blank value/reference sample without added polymer” utilizes 8 wt % water in addition to the soap noodles and perfume oil. That is, the water content of the soap bar is: (12×0.91+8) wt %, i.e., about 20 wt %. The other examples comprise adding polymers in the form of aqueous dispersions to the soap bars. In order that the water content of the soap bar be about 20 wt % in all cases, additional water is added alongside each polymer dispersion.

### Production of Bar Soap

An extruder (Sela Weber-Seelander screw press 33799/8000) was heated to 45° C. before use. The production of about 6 to 8 pieces of bar soap required altogether an amount of 1 kg of soap mass. To this end, the soap noodles were first coarsely ground and then forced through the extruder (large hole plate ø 5 mm). The ground product and the remaining input materials were then used to prepare a premix (see individual batches). This premix was thoroughly commixed in a bucket. The premix was introduced into the preheated extruder and forced five times through a large hole plate. This was followed by five passes using a small hole plate (ø 2 mm). This was followed by a revamp to a strand press. The mass was processed at 50° C. into a strand and pressed into shape in a manual press.

Alternatively, a twin-screw extruder (e.g., Coperion ZSK 18 MEGlab) may also be used to produce the bar soaps.

TABLE 1
Polymer numbers and monomer composition

| Polymer | Monomer composition of polymer (wt %) |
|---|---|
| Polymer A | ethyl acrylate (44-54%), methacrylic acid (35-45%), |
| | methacrylamide (9-11%), C18 alkyl |
| | (EO)25-methacrylate (0.25-0.75%), |
| | pentaerythrityl triallyl ether (PETAE) 0-0.1% |
| Polymer B | ethyl acrylate (44-54%), methacrylic acid (35-45%), |
| | acrylic acid (5-15%), PETAE (0.5-0.25%) |
| Polymer C | ethyl acrylate (40-60%) and methacrylic acid (40-60%) |
| Polymer D | A homopolymer of vinylpyrrolidone |
| Polymer E | methacrylic acid 45-55%, ethyl acrylate 40-45%, |
| | C18 alkyl (EO)25-methacrylate 5-10%, |
| | C22 alkyl (EO)20-40-methacrylate 5-10% |

Soap noodles: Cremer SAP BV 601 (from Cremer Oleo), INCI: Sodium Palmate, Sodium Kernelate, the soap noodles comprised 12 wt % of water.

Parfume oil: Cotton Touch DC10420 (from Symrise)

Soap 1: Blank Value/Reference Sample without Added Polymer

| | | |
|---|---|---|
| Soap noodles | % | 91.0 |
| Water | % | 8.0 |
| Perfume oil | % | 1.0 |

Soap 2 with Polymer A (0.5% Polymer Content) Add Mixture to Soap as 29.1% Dispersion

| | | |
|---|---|---|
| Soap noodles | % | 90.5 |
| Water | % | 6.8 |
| Polymer A | % | 1.7 |
| Perfume oil | % | 1.0 |

Soap 3 with Polymer A (2.0% Polymer Content) Add Mixture to Soap as 29.1% Polymer Dispersion

| | | |
|---|---|---|
| Soap noodles | % | 89.0 |
| Water | % | 3.1 |
| Polymer A | % | 6.9 |
| Perfume oil | % | 1.0 |

Soap 4 with Polymer B (0.5% Polymer Content) Add Mixture to Soap as 30.0% Polymer Dispersion

| | | |
|---|---|---|
| Soap noodles | % | 90.5 |
| Water | % | 6.8 |
| Polymer B | % | 1.7 |
| Perfume oil | % | 1.0 |

Soap 5 with Polymer B (2.0% Polymer Content) Add Mixture to Soap as 30.0% Polymer Dispersion

| | | |
|---|---|---|
| Soap noodles | % | 89.0 |
| Water | % | 3.3 |
| Polymer B | % | 6.7 |
| Perfume oil | % | 1.0 |

Soap 6 with Polymer C (0.5% Polymer Content) Add Mixture to Soap as 30.0% Polymer Dispersion

| | | |
|---|---|---|
| Soap noodles | % | 90.5 |
| Water | % | 6.8 |
| Polymer C | % | 1.7 |
| Perfume oil | % | 1.0 |

Soap 7 with Polymer C (2.0% Polymer Content) Add Mixture to Soap as 30.0% Polymer Dispersion

| | | |
|---|---|---|
| Soap noodles | % | 89.0 |
| Water | % | 3.3 |
| Polymer C | % | 6.7 |
| Perfume oil | % | 1.0 |

Soap 8 with Polymer D (0.5% Polymer Content) Add Mixture to Soap as 20.0% Polymer Solution in Water

| | | |
|---|---|---|
| Soap noodles | % | 90.5 |
| Water | % | 6.0 |
| Polymer D | % | 2.5 |
| Perfume oil | % | 1.0 |

Soap 9 with Polymer D (2.0% Polymer Content) Add Mixture to Soap as 20.0% Polymer Solution in Water

| | | |
|---|---|---|
| Soap noodles | % | 89.0 |
| Polymer D | % | 10.0 |
| Perfume oil | % | 1.0 |

Soap 10 with Polymer E (0.5% Polymer Content) Add Mixture to Soap as 30.0% Polymer Dispersion in Water

| | | |
|---|---|---|
| Soap noodles | % | 90.5 |
| Water | % | 6.8 |
| Polymer E | % | 1.7 |
| Perfume oil | % | 1.0 |

Soap 11 with Polymer E (2.0% Polymer Content) Add Mixture to Soap as 30.0% Polymer Dispersion in Water

| | | |
|---|---|---|
| Soap noodles | % | 89.0 |
| Water | % | 3.3 |
| Polymer E | % | 6.7 |
| Perfume oil | % | 1.0 |

Description of Smell Tests The smell of the soap was in each case assessed relative to the blank value without polymer. The smell was described as “+” when the soap with polymer has a stronger smell than the soap without polymer (blank value). The smell was described as “++” when the soap with polymer had a much stronger smell than the soap without polymer (blank value). The odor was described as “-” when the soap with polymer had a worse smell than the soap without polymer (blank value).
Smell Directly after Soap Production

The assessment panel numbered four people. They assessed the smell of the soap one day after the soap had been produced. The tables contain the raw data of the panelists' assessment.

TABLE 2
Assessment of smell of soaps with polymers relative
to blank value directly after soap production

polymer concentration

| Polymer | 0.50% | 2.00% |
|---|---|---|
| Polymer A | 4x “+” | 4x “++” |
| Polymer B | 4x “+” | 4x “++” |
| Polymer C | 4x “+” | 4x “++” |
| Polymer D | 1x “++”, 2x “+”, 1x “−” | 2x “++”, 1x “+”, 1x “−” |
| Polymer E | 2x “++”, 2x “−” | 1x “++”, 1x “+”, 2x “−” |

Smell after Storage of Soaps at 21° C. (4 Weeks)

The assessment panel numbered five people. They assessed the smell of the soap four weeks after the soap had been produced. The tables contain the raw data of the panelists' assessment.

TABLE 3
Assessment of smell of soaps with polymers relative to blank
value after 4 weeks' storage at 21° C.

polymer concentration

| Polymer | 0.50% | 2.00% |
|---|---|---|
| Polymer A | 4x “+”, 1x “−” | 3x “++”, 2x “+” |
| Polymer B | 5x “+” | 4x “++”, 1x “+” |
| Polymer C | 3x “++”, 2x “+” | 2x “++”, 2x “+”, 1x “−” |
| Polymer D | 4x “+”, 1x “−” | 3x “++”, 2x “+” |
| Polymer E | 1x “++”, 3x “+”, 1x“−” | 4x “++”, 1x “+” |

Smell after Storage of Soaps at 40° C. (4 Weeks)

The assessment panel numbered five people. They assessed the smell of the soap four weeks after the soap had been produced. The tables contain the raw data of the panelists' assessment.

TABLE 4
Assessment of smell of soaps with polymers relative to blank
value after 4 weeks' storage at 40° C.

polymer concentration

| Polymer | 0.50% | 2.00% |
|---|---|---|
| Polymer A | 5x”+” | 5x “++” |
| Polymer B | 5x”+” | 4x “++”, 1x “+” |
| Polymer C | 2x “++”,3x “+” | 3x “++”, 2x “+” |
| Polymer D | 2x “++”, 3x “+” | 2x “++”, 3x “+” |
| Polymer E | 1x “++”, 4x “−” | 4x “++”, 1x “+” |

### Evaluation and Summary of Smell Tests

The assessments of the smell of the bar soaps by 4 or 5 people (see Tables 2 to 4) are clear in verifying that the inventive polymers do improve the smell of soaps. There were but few “outliers” in the assessment. The smell was unambiguously improved by the added polymers. This is true not only directly after soap production (see Table 2) but also after storage for a period of 4 weeks after storage at 21° C. (see Table 3) and after storage at 40° C. (see Table 4).

### Evaluation and Summary of Soap Processability, Consistency and Appearance Improved by Means of the Inventive Polymers

The production of the bar soaps 1 to 11 demonstrates clearly that adding the polymers improves the processability and consistency by making the bar soap mass much more uniform and shapeable. Compared to Soap 1 without polymers the polymer-containing soaps were less crumbly, much more homogeneous and smoother resulting in an enhanced and optimized extruding and pressing behavior without gaining stickiness. The manufactured bar soap appearances increased evidently from a coarse, streaky surface (Soap 1) to sleek and glossy surfaces (Soaps 2 to 11). This persists for the storage period of 4 week at 21° C. and 40° C.

1. A soap bar comprising
soap,
at least one perfume oil,
at least one polymer,
optionally water, and
optionally further known cosmetic ingredients other than the soap, the perfume oil, the polymer and the water,
wherein the at least one polymer is a water-soluble polymer having a water solubility of at least 0.01 g of polymer in 100 g of water at 20° C. at one or more than one pH value in the range between 4 and 9,
and wherein the at least one polymer is selected from the group consisting of
a polymer in which more than 20 w % of the repeating units of the polymer are repeating units derived from at least one ethylenically unsaturated, polymerizable monomer having at least one acid group, wherein these repeating units are present as free acids or as salts, wherein when they are present as salts the salts are preferably alkali metal salts, especially sodium salts, and
a polymer comprising repeating units derived from N-vinylpyrrolidone, wherein the proportion of these repeating units in the polymer is at least 50 w %.

2. The soap bar according to claim 1 wherein the soap is selected from the group consisting of
the sodium salt of a fatty acid or fatty acid mixture, wherein the fatty acid is a linear aliphatic monocarboxylic acid having 6 to 24, and wherein 0 to 10 w % of said sodium salt is a potassium salt,
a syndet or mixture of syndets, and
a mixture of one or more syndets and the sodium salt of a fatty acid or fatty acid mixture, wherein the fatty acid is a linear aliphatic monocarboxylic acid having 6 to 24, and wherein 0 to 10 w %, preferably 0 to 5 w % of said sodium salt is a potassium salt.

3. The soap bar according to claim 2 wherein the soap is a syndet or mixture of syndets, and wherein the syndets are selected from the group consisting of a sodium salt of an acylisethionate, a sodium salt of an acyl glutamate, a sodium salt of an alkyl sulfoacetate, a sodium salt of a fatty alcohol sulfate, and a sodium salt of a fatty alcohol sulfosuccinate.

4. The soap bar according to claim 1 wherein the at least one perfume oil is a scent selected from the group consisting of an essential oil of vegetable origin, an essential oil of animal origin, and a synthetic scent.

5. The soap bar according to claim 1 wherein the at least one polymer is selected from the group consisting of
a polymer in which more than 20 w % of the repeating units of the polymer are repeating units derived from acrylic acid and/or from methacrylic acid, wherein these repeating units are present as free acids or as salts, and
a polymer comprising repeating units derived from N-vinylpyrrolidone, wherein the proportion of these repeating units in the polymer is at least 50 w %, and wherein the polymer optionally further comprises repeating units derived from methacrylamide and/or vinyl acetate and/or vinylimidazole and/or quaternized vinylimidazole, wherein the quaternization is a N-methylation.

6. The soap bar according to claim 1 wherein the at least one polymer is selected from the group consisting of
a polymer comprising repeating units derived from 21 to 60 w % of methacrylic acid, 40-60 w % of ethyl acrylate, 0-20 w % of acrylic acid, 0-0.25 w % of a bi-, tri- or tetrafunctional monomer, 0 to 20 w % methacrylamide, and 0-10 w % of a 012 to 022 alkyl (EO)₀₋₁₀₀-methacrylate,
a polymer comprising repeating units derived from 40-60 w % of ethyl acrylate, 40-60 w % of methacrylic acid, and 0 to 1 w % of allylpentaerythritol;
a polymer comprising repeating units derived from 45-50 w % of ethyl acrylate, 37-43 w % of methacrylic acid, 5-15 w % of methacrylamide, 0.1 to 5 w % of C₁₈ alkyl (EO)25-methacrylate, and 0.01 to 1 w % of allylpentaerythritol; and
a polymer comprising repeating units derived from 50-60 w % of ethyl acrylate, 30-40 w % of methacrylic acid, 5-15 w % of acrylic acid, and 0.01 to 1% of allylpentaerythritol.

7. The soap bar according to claim 1 wherein the at least one polymer is selected from the group consisting of (quantitative particulars in w %)
a polymer comprising repeating units derived from ethyl acrylate (44-54%), methacrylic acid (35-45%), methacrylamide (9-11%), C₁₈ Alkyl (EO)25-methacrylate (0.25-0.75%) and pentaerythrityl triallyl ether (0-0.1%),
a polymer comprising repeating units derived from ethyl acrylate (44-54%), methacrylic acid (35-45%), acrylic acid (5-15%) and pentaerythrityl triallyl ether (0.5-0.25%),
a polymer comprising repeating units derived from ethyl acrylate (40-60%) and methacrylic acid (40-60%),
N-vinylpyrrolidone homopolymer, and
a polymer comprising repeating units derived from methacrylic acid (45-55%), ethyl acrylate (40-45%), C₁₈ alkyl (EO)25-methacrylate (5-10%), 022 alkyl (EO)20-40-methacrylate (5-10%).

8. The soap bar according to claim 1 wherein the soap bar comprises
60-99.9 w % of soap,
0.01 to 10 w % of the at least one perfume oil,
0.1-10 w % of the at least one polymer,
0 to 40 w % of water, and
0 to 10 w % of further known cosmetic ingredients other than the soap, the perfume oil, the polymer, and the water.

9. The soap bar according to claim 1 wherein the soap bar comprises
65 to 90 w % of soap,
0.1 to 5 w % of the at least one perfume oil,
0.2 to 5 w % of the at least one polymer,
10 to 25 w % of water, and
0 to 5 w % of further known cosmetic ingredients other than the soap, the perfume oil, the polymer, and the water.

10. The soap bar according to claim 1 wherein the soap bar comprises
70 to 89 w % of soap,
0.3 to 2 w % of the at least one perfume oil,
0.5 to 2 w % of the at least one polymer,
10 to 25 w % of water, and
0 to 5 w % of further known cosmetic ingredients other than the soap, the perfume oil, the polymer, and the water.

11. A method of manufacturing the soap bar according to claim 1, comprising
providing the soap, optionally comprising water,
adding the polymer to the soap in the form of a dispersion or solution in water, and
adding the perfume oil, optionally further water and optionally the optionally present further known cosmetic ingredients before or after the step of adding the polymer.
